(19) United States
(12) Patent Application Publication
(10) Pub. No.: US 2002/0188557 A1
(43) Pub. Date: Dec. 12, 2002

(54) Admission ticket producing apparatus, admission ticket producing system, admission ticket producing and selling method and recording medium

(75) Inventor: Kanenori Ochiai, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/163,592

(22) Filed: Jun. 7, 2002

(30) Foreign Application Priority Data
Jun. 8, 2001 (JP) 2001-174220

(51) Int. Cl. G06F 17/60

(52) U.S. Cl. 705/38

(57) ABSTRACT

In order to enable to purchase easily an admission ticket enabling to prevent illegality, an admission ticket producing system including a terminal which inputs and outputs attendant information including at least an attendant verification image enabling verifying an attendant and personal information of the attendant, and an admission ticket producing apparatus comprising an information obtaining section which obtains at least the attendant information including and a recording section which records the attendant information obtained by the information obtaining section and ticket information for permitting admission, on an admission ticket, is provided.

### BACKGROUND OF THE INVENTION

1. Field of the Invention

The present invention relates to an admission ticket producing apparatus, an admission ticket producing system, an admission ticket producing and selling method, and a recording medium. More particularly, the present invention relates to an admission ticket producing apparatus which produces an admission ticket for attending a concert, a sporting event or the like, an admission ticket producing system including the admission ticket producing apparatus, an admission ticket producing and selling method, and a recording medium on which a program for producing and selling admission ticket is recorded.

2. Description of the Related Art

In general, a company sponsoring a concert or a sporting event consigns producing an admission ticket for the concert or the sporting event to a printing company or the like, the admission ticket, having a format designated by the company sponsoring the concert or the sporting event, is produced by the printing company. Thus, the admission ticket for the concert or the sporting event is sent to a purchaser.

Recently, in order to prevent illegality, such as resale of an admission ticket, a type of an admission ticket, on which personal information such as an address, a name, a date of birth, and the like of a purchaser is recorded, increases. The personal information recorded on the admission ticket is checked by a identification card or the like of a ticket holder having the admission ticket when the ticket holder entering to a place (venue) for the concert or the sporting event.

The technique relating to this type of the admission ticket is proposed in, for example, Japanese Patent Laid-Open (JP-A) No. 7-125482. In the technique recited in JP-A No. 7-125482, an admission ticket, displaying an image of a person and date information formed by a video printer or an instant camera on a surface of a supporting sheet, is proposed. According to the admission ticket recited in JP-A No. 7-125482, it can be checked whether or not illegal entrance occurs when a ticket holder enters with using the admission ticket by checking the date displayed on the admission ticket, similar to a case of a conventional admission ticket. Further, it can be verified whether or not the ticket holder is a purchaser of the admission ticket by comparing the ticket holder with the image of the person displayed on the admission ticket. Therefore, illegal usage of the admission ticket by the third person can be prevented.

However, in the technique of the admission ticket recited in JP-A No. 7-125482, the image of the an attendant is recorded on a photographic printing paper. Therefore, it is necessary that, when purchasing the admission ticket, the purchaser of the admission ticket sends a negative film on which the image of the purchaser is recorded to an admission ticket selling company (an admission ticket vender) and the image of the purchaser is recorded on the photographic printing paper to produce the admission ticket by the admission ticket selling company. Or, it is necessary that, when purchasing the admission ticket, the attendant himself or herself goes to a place where the admission ticket is sold in order to be photographed and the admission ticket, of which the image of the attendant is recorded on the photographic printing paper, is produced. Therefore, in the technique relating to the admission ticket recited in JP-A No. 7-125482, there is a problem that purchase of an admission ticket is complicated.

### SUMMARY OF THE INVENTION

In view of the aforementioned problems, it is an object of the present invention to provide an admission ticket producing apparatus, an admission ticket producing system, an admission ticket producing and selling method and a recording medium relating to an admission ticket which makes it difficult for the admission ticket to be illegally resold and/or used and which can be purchased easily.

In order to archive the object mentioned above, a first aspect of the present invention is an admission ticket producing apparatus comprising: an information obtaining section which obtains attendant information including at least an attendant verification image enabling verifying an attendant (attendee) and personal information of the attendant, obtained from the outside; and a recording section which records the attendant information obtained by the information obtaining section and admission ticket information for permitting entrance, on an admission ticket.

In a second aspect of the present invention according to the first aspect, the information obtaining section obtains an address of the attendant as the personal information, and the recording section records the address of the attendant on an envelope member for sending the admission ticket to the attendant on the basis of the personal information obtained by the information obtaining section.

In a third aspect of the present invention according to the first aspect or the second aspect, the information obtaining section is a communicating and obtaining section which transmits and receives information by communication including the internet.

In a fourth aspect of the present invention according to the second aspect, the recording section further records identifying information corresponding to the attendant information on the admission ticket and the envelope member.

A fifth aspect of the present is an admission ticket producing system including: a terminal which inputs and outputs attendant information including at least an attendant verification image enabling verifying an attendant and personal information of the attendant; and the admission ticket producing apparatus according to one of the first aspect through the fourth aspect.

In a sixth aspect of the present invention according to the fifth aspect, the attendant information and the admission ticket information recorded on the admission ticket by the recording section are collated with condition for permitting entrance.

In a seventh aspect of the present invention according to the fifth aspect or the sixth aspect, the terminal is a wireless terminal enabling photographing an image and inputting the attendant information.

An eighth aspect of the present invention is an admission ticket producing and selling method for producing and selling an admission ticket on the basis of application for purchasing admission ticket, including: an inputting step for inputting attendant information including at least an attendant verification image enabling verifying an attendant and personal information of the attendant by an inputting section; an outputting step for outputting the attendant information inputted at the inputting step; and a recording step for recording the attendant information outputted at the outputting step and admission ticket information for permitting entrance, on an admission ticket.

In a ninth aspect of the present invention according to the eighth aspect, an address of the attendant is inputted by the inputting section as the personal information, and the method further includes an address recording step in which the address of the attendant is recorded on an envelope member for sending the admission ticket to the attendant on the basis of the personal information inputted at the inputting step.

In a tenth aspect of the present invention according to the ninth aspect, the method further includes an admission ticket recording step for recording identifying information corresponding to the attendant information on the admission ticket; and an envelope member recording step for recording the identifying information on the envelope member on which the address of the attendant is recorded in the address recording step.

In an eleventh aspect of the present invention according to one of the eighth aspect, the ninth aspect or the tenth aspect, the method further includes a collating step in which the attendant information and the admission ticket information recorded in the recording step are collated with condition for permitting entrance.

A twelfth aspect of the present invention is a recording medium on which a program, readable by a computer, for executing the admission ticket producing and selling method for producing and selling an admission ticket on the basis of application for purchasing admission ticket according to any one of the eighth aspect through the eleventh aspect.

In the first aspect of the present invention, the information obtaining section obtains the attendant information including at least the attendant verification image enabling verifying the attendant and the personal information of the attendant, from the outside. The attendant verification image is, for example, an image of the attendant, an image of a fingerprint of the attendant, or the like. The personal information is, for example, a residence (an address), a name, an age, a date of birth, a telephone number, an e-mail address, and the like, of the attendant. For example, the information obtaining section obtains the attendant information which is obtained from a user who applies (requests) to purchase admission ticket via mailing or the like. Or, the information obtaining section obtains the attendant information which is obtained from a terminal or the like connected to the information obtaining section.

In the recording section, the attendant information obtained by the information obtaining section and the admission ticket information (for example, an entrance data and time, a name of place (venue), a name of event and the like) are recorded on the admission ticket.

Namely, the admission ticket is easily produced by the recording section by that the attendant information including the attendant verification image and the personal information of the attendant is transmitted from the terminal or the like connected to the information obtaining section. Accordingly, the admission ticket can be easily purchased because purchasing of the admission ticket can be applied by operating the terminal or the like connected to the information obtaining section.

Moreover, because the attendant verification image is recorded on the admission ticket by the recording section, it can be prevented that a person other than a person whose image is recorded on the admission ticket uses the admission ticket. Accordingly, this admission ticket can make it difficult for the admission ticket to be illegally resold and/or used.

In the second aspect of the present invention according to the first aspect of the present invention, the information obtaining section obtains the address of the attendant as the personal information. Therefore, the recording section records the address of the attendant, obtained by the information obtaining section, on the envelope member such as an envelope for sending the admission ticket to the attendant. Accordingly, sending of the admission ticket can be easily performed.

In third aspect of the present invention according to the first aspect or the second aspect, the communicating and obtaining section which transmits and receives information by communication including network, is used as the information obtaining section. For example, as the communicating and obtaining section, a network such as the internet or the like can be used.

In the fourth aspect of the present invention according to the second aspect, due to that the recording section further records the identifying information corresponding to the attendant information on the admission ticket and the recording section further records the identifying information corresponding to the attendant information on the envelope member, the envelop member on which the address of the attendant is recorded and the corresponding admission ticket can be combined by using the both identifying information recorded on the admission ticket and the envelope member when entering the produced ticket into the envelope member such as the envelop for sending the produced admission ticket. Accordingly, sending of the produced admission ticket can be easily performed. Moreover, management of the sending admission ticket and customer information can be easily performed by using the identifying information.

In the fifth aspect of the present invention, because the admission ticket producing system includes the terminal in which the attendant information including at least the attendant verification image enabling verifying the attendant and the personal information of the attendant is inputted and outputted; and the admission ticket producing apparatus according to one of the first aspect through the fourth aspect, for example, the admission ticket producing apparatus comprising the information obtaining section which obtains at least the attendant information and the recording section which records the attendant information obtained by the information obtaining section and the admission ticket information for permitting entrance on the admission ticket, as mentioned above, the admission ticket can be produced by the admission ticket producing apparatus by that the attendant information is merely inputted by using the terminal and the inputted attendant information is merely outputted to the admission ticket producing apparatus. Therefore, the admission ticket can be purchased easily.

Also, because the attendant verification image is recorded on the admission ticket by the recording section, this admission ticket can make it difficult for the admission ticket to be illegally resold and/or used.

In the sixth aspect of the present invention according to the fifth aspect, the attendant information and the admission ticket information recorded on the admission ticket are collated with the condition for permitting entrance (for example, the attendant information and the admission ticket information such as date and time for entrance obtained by the communicating and obtaining section). Accordingly, it is possible to judge as to whether or not an admission ticket was produced by the (authorized) ticket producing apparatus when an attendant enters and uses the admission ticket by using a collating device, which collates the attendant information and the admission ticket information recorded on the admission ticket with the condition for permitting entrance, installed at a place (a venue) where the admission ticket is used such as a gate of the place. Accordingly it is impossible to enter the place by using an illegally produced ticket. Therefore, it is possible to detect as to whether or not the admission ticket is illegally produced.

In the seventh aspect of the present invention according to the fifth aspect or the sixth aspect, the wireless terminal enabling photographing an image of person and inputting the attendant information is used as the terminal. It is possible to apply to purchase admission ticket by that the image of the person is outputted to the admission ticket producing apparatus as the attendant verification image and the attendant information is outputted to the admission ticket producing apparatus, by using a wireless telephone provided with an image pickup element and enabling photographing an image such as the image of the person and the like, by using a PDA terminal or a note-type personal computer combined with a digital camera or the like. Accordingly, it becomes possible to purchase the admission ticket easily.

In the eighth aspect of the present invention, when applying to purchase ticket, the attendant information including at least the attendant verification image enabling verifying the attendant such as an image of the attendant, an image of a fingerprint of the attendant, or the like, and the personal information such as a residence (an address), a name, an age, a date of birth, a telephone number, an e-mail address, and the like, of the attendant, is inputted by the inputting section in the inputting step, and the attendant information inputted at the inputting step is outputted in the outputting step. Accordingly, it is possible to record the attendant information outputted in the outputting step and the admission ticket information (for example, an entrance data and time, a name of place, a name of event and the like) are recorded on the admission ticket in the recording step. Accordingly, as similarly to the first aspect, the admission ticket can be easily purchased because the admission ticket can be applied to purchase by operating the terminal or the like connected to the information obtaining section. Moreover, because the attendant verification image is recorded on the admission ticket in the recording step, this admission ticket makes it difficult for the admission ticket to be illegally resold and/or used.

In the ninth aspect of the present invention according to the eighth aspect, the address of the attendant is inputted by the inputting section as the personal information, and the address recording step is further included. Accordingly, the address inputted in the inputting step, of the attendant can be recorded on the envelope member such as an envelope for sending the admission ticket to the attendant. Therefor, as similarly to the second aspect, the admission ticket can be sent easily.

In the tenth aspect of the present invention according to the ninth aspect, the admission ticket recording step for recording identifying information corresponding to the attendant information on the admission ticket and the envelope member recording step for recording the identifying information on the envelope member on which the address of the attendant is recorded in the address recording step, are further included. Accordingly, as similarly to the fourth aspect, the envelop member on which the address of the attendant is recorded and the corresponding admission ticket can be combined by using the both identifying information recorded on the admission ticket and the envelope member when entering the produced ticket into the envelope member such as the envelop for sending the produced admission ticket. Therefore, sending of the produced admission ticket can be easily performed.

In the eleventh aspect of the present invention according to one of the eighth aspect through the tenth aspect, the collating step in which the attendant information and the admission ticket information recorded in the recording step are collated with condition for permitting entrance (for example, the attendant information and the admission ticket information such as date and time for entrance inputted in the inputting step), is further included. Therefore, as similarly to the sixth aspect, it is possible to detect as to whether or not the admission ticket is illegally produced.

### BRIEF DESCRIPTION OF THE DRAWINGS

FIG. 1 is a structural schematic diagram showing an admission ticket producing system relating to a first embodiment of the present invention.

FIG. 2 is a structural schematic diagram showing a digital laboratory system used as an output section in the admission ticket producing system relating to embodiments of the present invention.

FIG. 3 is a perspective view showing appearance of the digital laboratory system used as the output section in the admission ticket producing system relating to embodiments of the present invention.

FIG. 4 is a functional block diagram explaining process executed in an image processing section of the digital laboratory system used as the output section in the admission ticket producing system relating to embodiments of the present invention.

FIG. 5 is a diagram showing distribution of an admission ticket relating to the first embodiment of the present invention.

FIG. 6 is a flow chart showing flow of processing executed at a client operated by a user.

FIG. 7 is a flow chart showing flow of processing executed at a server owned by a manager who manages selling tickets.

FIG. 8 is a flow chart showing flow of processing executed at LAN side owned by a contractor who contracts with the manager managing selling tickets.

FIG. 9A shows one example of the admission ticket produced by the admission ticket producing system relating to the embodiments of the present invention.

FIG. 9B shows another example of the admission ticket produced by the admission ticket producing system relating to the embodiments of the present invention.

FIG. 10 is a structural schematic diagram showing an admission ticket producing system relating to a second embodiment of the present invention.

FIG. 11 is a diagram showing another example of distribution of the admission ticket.

### DESCRIPTION OF THE PREFERRED EMBODIMENTS

Referring to drawings, embodiments of the present invention will be described hereinafter in detail.

### First Embodiment

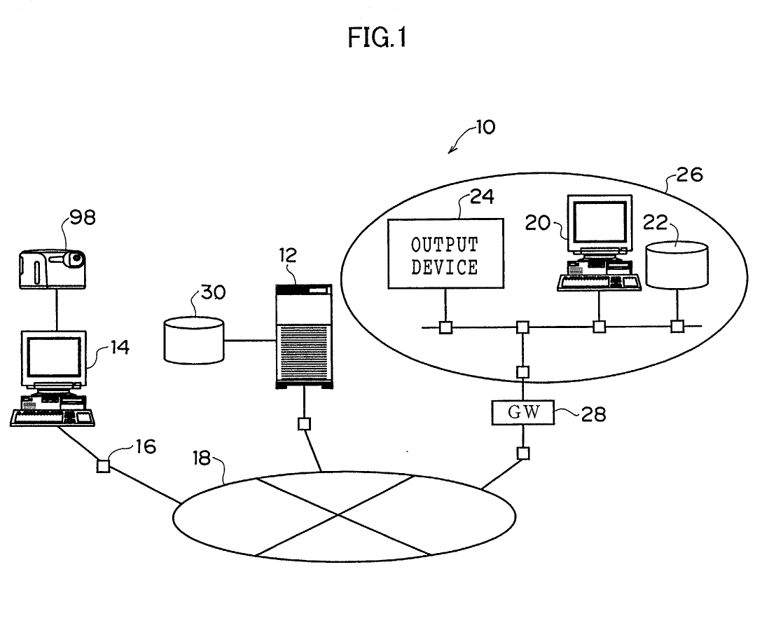

An admission ticket producing system 10 relating to the present embodiment is shown in FIG. 1. In the admission ticket producing system 10, a server 12 owned by a manager who manages selling admission ticket, a client 14 owned by a user who uses the admission ticket producing system 10 is each connected to the internet 18 via a connecting device 16, such as a modem, a router, TA (Terminal Adapter) or the like. Also, in the admission ticket producing system 10, LAN (Local Area Network) 26, in which a terminal device 20, a hard disk 22 and an output device 24 owned by a contractor who contracts with the above mentioned manager are connected via a bus, is connected to the internet 18 via a gateway system 28 or the like.

Note that the server 12, the connecting device 16, the internet 18, the LAN 26 and the gateway system 28 correspond to an information obtaining section and a communicating and obtaining section of aspects of the present invention, the output device 24 corresponds to a recording section of the aspects of the present invention, and the client 14 corresponds to a terminal of the aspects of the present invention.

At the terminal device 20 and the output device 24 connected to the LAN 26, various type of image processing and edition for image data obtained from the internet 18, other terminals or the like can be performed, and the image data subject to the image processing and the edition can be outputted.

Each of the server 12, the client 14 and the terminal device 20 is provided with an inputting device for inputting various types of information such as a keyboard, a mouse or the like, a monitor (a display device) for displaying various types of menu screens, processing results and the like, and a printer which prints various types of information. Because this hardware-structures is in general, explanation for those is omitted.

The server 12 relating to the present embodiment functions as WWW (World Wide Web) server and the client 14 and the terminal device 20 including the output device 24 relating to the present embodiment function as WWW client.

Namely, WWW browser is installed in the client 14 and the terminal device 20, and access to the server 12 is possible via the internet 18 by activating the WWW browser. An access point is designated by URL (Uniform Resource Locator).

IP (Internet Protocol) address is used for identification of the client 14 and the terminal device 20. However, another code for specifying point such as URL or the like may be used.

The server 12 is connected to a hard disk 30. A homepage data for displaying a homepage for selling admission tickets on each monitor, and a format for purchasing admission ticket, for which the user purchases the admission ticket, in a page for purchasing admission ticket included in the homepage, are stored in the hard disk 30. Also, admission ticket purchase information, which is inputted on the basis of the format for purchasing admission ticket and sent by the user, is stored in the hard disk 30 as database. When the admission ticket purchase information is stored in the hard disk 30 as the database, identifying information, such as a serial number, a bar code or the like corresponding to the admission ticket purchase information, for identifying the admission ticket purchase information, is stored in the hard disk 30 together with the admission ticket purchase information such that each admission ticket purchase information is identified.

The admission ticket purchase information is information which includes personal information, a user verification image and the like. The personal information is, for example, an address (a residence), a name, an age, a date of birth, a telephone number, an e-mail address, and the like, of the user who applies to purchase admission ticket. The user verification image (for example, a picture of the user, an image of a fingerprint) enables verifying the user who applies to purchase admission ticket. The identifying information is information representing such as the serial number, the bar code or the like added to the respective admission ticket purchase information correspondingly.

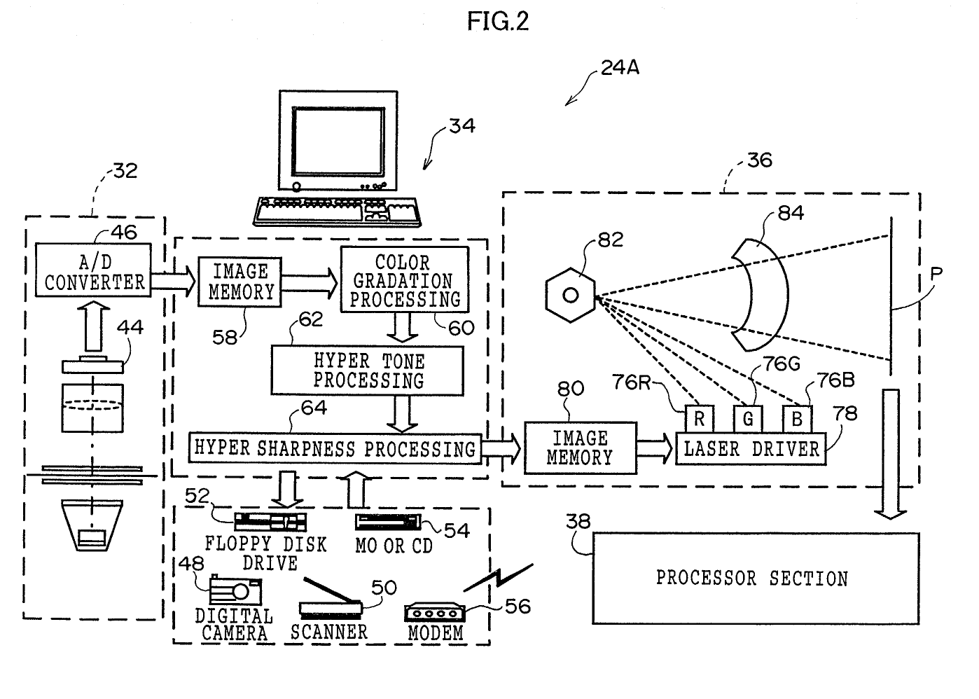

Next, the output device 24 connected to the LAN 26 will be explained. A digital laboratory system 24A shown in FIG. 2 can be used as the output device 24. In the present embodiment, the digital laboratory system 24A is used as the output device 24.

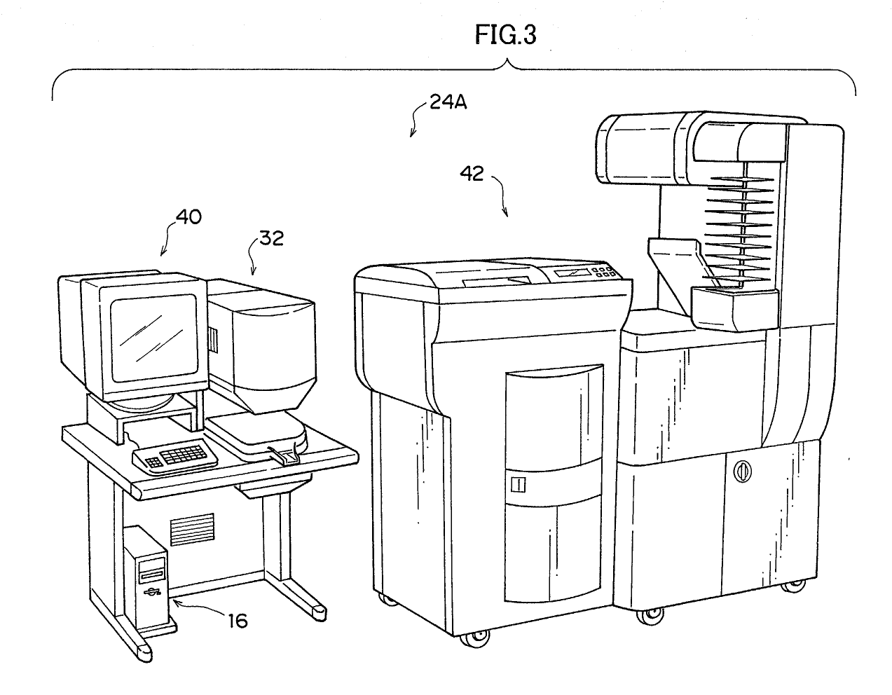

As shown in FIG. 2, the digital laboratory system 24 is structured to include a film scanner 32, an image processing section 34, a laser printer section 36, and a processor section 38. The film scanner 32 and the image processing section 34 are integrated to form an input section 40 shown in FIG. 3. The laser printer section 36 and the processor section 38 are integrated to form an output section 42 shown in FIG. 3.

The film scanner 32 is used to read a flame image recorded on a photographic film such as a negative film and a reversal film. Examples of the photographic film on which a flame image to be read is recorded are a photographic film in 135 magazines, a photographic film in 110 magazines, a photographic film with a transparent magnetic layer formed thereon (i.e., a photographic film in 240 magazines: a so-called APS film) , and photographic films in 120 magazines and 220 magazines (Brownie size). The film scanner 34 reads the above-described flame image to be read by an image reading element 44 such as an area CCD, a liner CCD or the like, the read image is subject to an A/D conversion at an A/D converter 46, and image data is outputted to the image processing section 34.

The image processing section 34 is structured to be inputted image data (scan data) outputted from the film scanner 32. Also, the image processing section 34 is structured to enable be inputted, from the outside, image data obtained by photographing using a digital camera or the like, image data obtained by reading an original (for example, a reflection original) by a scanner 50 (flatbet type scanner), image data generated by a computer or the like other than this system, and recorded on a recording medium by a floppy disk drive 52, a MO or CD drive 54, communication image data received via a modem 56. Namely, image data obtained from the internet 18 via the modem 56 can be received in the image processing section 34.

The image processing section 34 stores the inputted image data in an image memory 58, performs image processings such as various types of corrections at a color gradation processing section 60, a hyper tone processing section 62 and a hyper sharpness processing section 64, and outputs image recording data to the laser printer section 36. Also, the image processing section 34 can output the image data subject to the image processings to the outside as an image file. For example, the image data can be outputted to an image recording medium such as a FD, MO, CD-R or the like, or can be sent to another image processing device via a communication line.

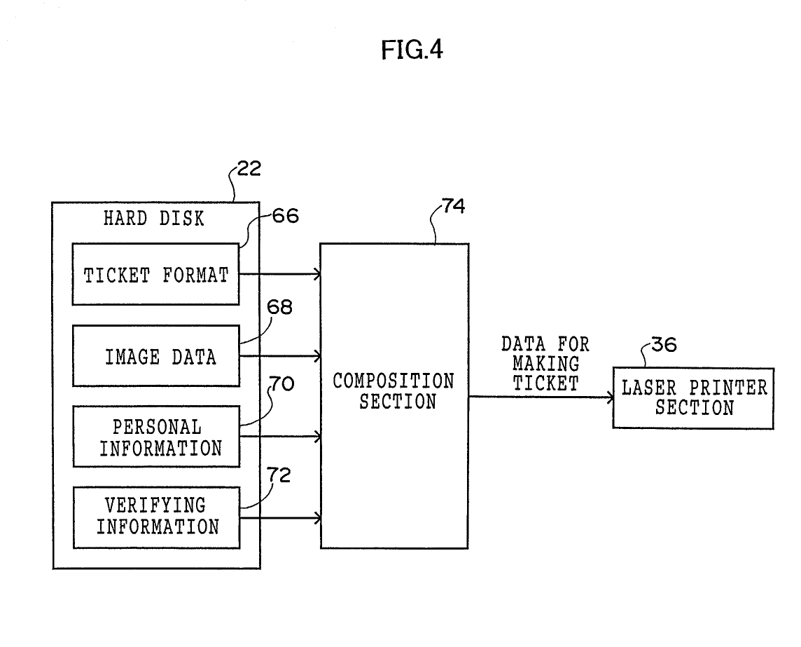

As shown in FIG. 4, a composition section 74, which composes image data 68, personal information 70 and identification information 72 with an admission ticket format 66, is provided at the image processing section 34. The admission ticket format 66 is a format for making admission ticket and stored in the hard disk 22 connected to the LAN 26. The image data 68 represents a user verification image inputted from the outside. The personal information 70 is formed by, for example, text data. The personal information 70 is included in the admission ticket purchase information and inputted from the outside. The identification information 72 corresponds to the respective admission ticket purchase information. The image data 68, the personal information 70 and the identification information 72 are composed in accordance with the admission ticket format 66, and outputted to the laser printer section 36 as data for making admission ticket of one image.

A function, which is shown in FIG. 4, provided in the image processing section 34, is provided at the digital laboratory system 24A in the present embodiment. However, the function may be provided at the terminal device 20 connected to the LAN.

The laser printer section 36 includes laser light sources of R, G and B and applies laser light modulated in correspondence with image data for recording (which is stored in an image memory 80 temporary) inputted from the image processing section 34 onto a photographic printing paper P by controlling a laser driver 78, so as to record an image on the photographic printing paper P by a scanning exposure. In the present embodiment, the scanning exposure is performed by an optical system including a polygon mirror 82 and f lens 84. Further, a processor section 38 effects various processing including a color development, a bleach-fix, a washing, and a drying for the photographic printing paper P on which the image is recorded by the scanning exposure in the laser printer section 36. As a result, the image is formed on the photographic printing paper P.

The digital laboratory system 24A is used as the output device 24 in the present embodiment. However, an inkjet printer, a heat developing type printer or the like is alternatively used as the output device 24.

Next, an operation of the admission ticket producing system relating to the present embodiment will be described.

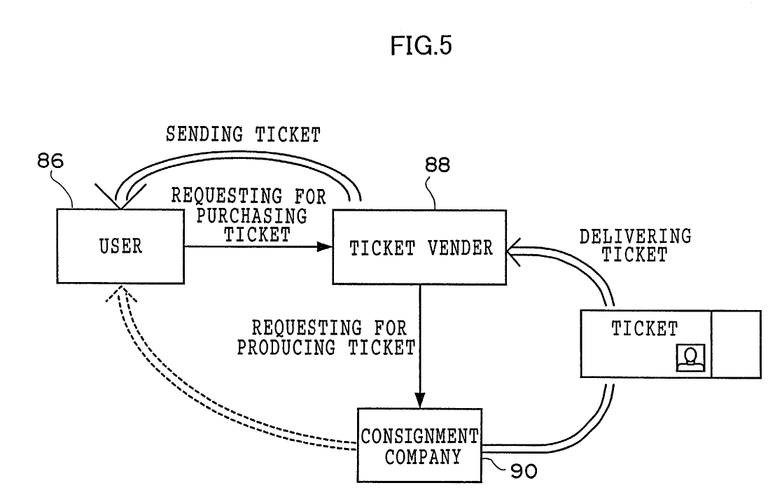

A flow of processing in the present embodiment, from a time when a user applies an admission ticket and then the admission ticket is produced until a time when the admission ticket is sent to the user, is shown in FIG. 5. FIG. 5 shows a case as follows. The user 86 applies to purchase the admission ticket with a manager (an admission ticket selling company (an admission ticket vender) 88) who manages selling admission tickets. The admission ticket selling company 88 orders to produce the admission ticket to a consignment company 90, such as a printing company, a photographer (a photograph studio) or the like, contracting with the admission ticket selling company 88. The consignment company 90 produces the admission ticket and delivers the admission ticket to the admission ticket selling company 88. The admission ticket selling company 88 sends the admission ticket to the user 86. Alternatively, the admission ticket may be directly sent to the user 86 from the consignment company 90, as shown in dotted line in FIG. 5.

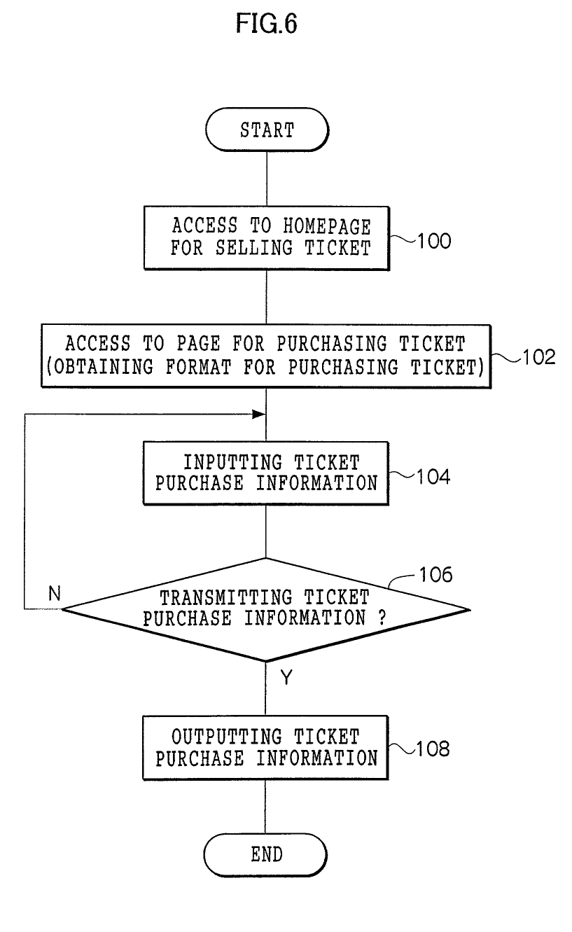

First, processing executed at the client 14 when the user 86 operates the client 14 to apply to purchase admission ticket will be described, with referring to a flow chart shown in FIG. 6.

In step 100, the user 86 operates the client 14 owned by the user 86 to access a homepage for selling admission tickets. Namely, the user 86 accesses to the server 12 by that the WWW browser is activated and URL representing an access point of the server 12 owned by the manager (the admission ticket selling company 88) who manages selling admission tickets is inputted.

Next, in step 102, the user 86 operates the client 14 to access to a page for purchasing admission ticket. The user 86 can access to the page for purchasing admission ticket by executing a predetermined inputting relating to the page for purchasing admission ticket at the homepage displayed on a monitor of the client 14 owned by the user 86 due to accessing to the server 12 in the way mentioned above. Thus, the format for purchasing admission ticket stored in advance in the server 12 is sent to the client 14, and the user 86 can obtain the format for purchasing admission ticket.

In step 104, the user 86 inputs the admission ticket purchase information in accordance with the format for purchasing admission ticket by using the client 14. The user 86 inputs the admission ticket purchase information in such a manner in which image data representing user verification image which enables to verify individual (the user 86) is attached to the format for purchasing admission ticket, and the personal information is also inputted. The user verification image is, for example, an image of a picture of the user 86 photographed by a digital camera 48 or the like, or an image of the finger print of the user 86 read by the scanner or the like. The personal information is, for example, a residence, a name, an age, a date of birth, a telephone number, an e-mail address, and the like, of the user 86.

Next, in step 106, it is determined whether or not the admission ticket purchase information is sent. Namely, it is determined whether or not each inputting is completed in accordance with the format for purchasing admission ticket without omission and sending of the admission ticket purchase information is designated. When the determination is negative, the process returns to the step 104, and the user 86 again inputs the admission ticket purchase information.

When the determination is affirmative in the step 106, the process proceeds to step 108 in which the admission ticket purchase information is outputted to the server 12 via the connection device 16 and the internet 18 from the client 14. Thus, the processing at the client 14 side is completed.

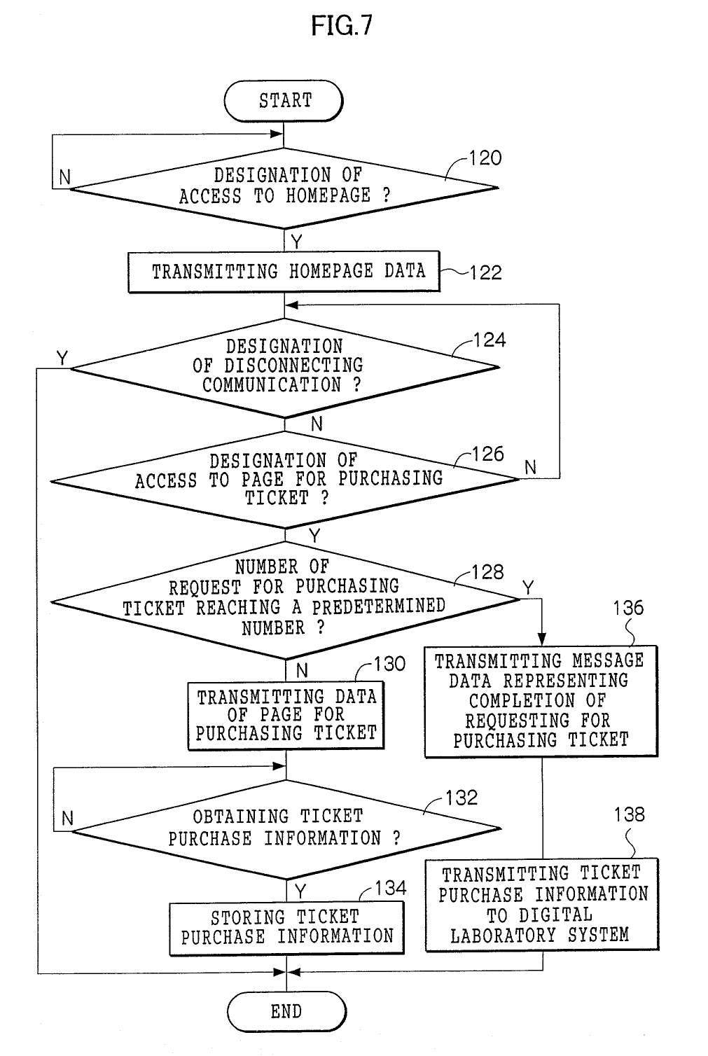

Next, processes executed at the server 12 owned by the manager (the admission ticket selling company 88) who manages selling admission tickets when the admission ticket is produced and sold will be described, with referring to a flow chart shown in FIG. 7.

In step 120, it is determined whether or not designation of accessing to the homepage from the client 14 of the user 86 is inputted to the server 12. When the determination is negative in the step 120, the server standbys until the determination becomes affirmative. Namely, the server 12 standbys until the designation of accessing to the homepage from the client 12 of the user 86 is inputted to the server 12.

When the determination is affirmative in the step 120, the process proceeds to step 122, and the homepage data for displaying the homepage is sent to the client 14 of the user 86.

In step 124, it is determined whether or not designation of disconnecting communication is inputted to the server 12 from the client 14 of the user 86. When the determination is negative in the step 124, the process proceeds to step 126. In the step 126, it is determined whether or not designation of accessing to the admission ticket purchase page for purchasing admission ticket is inputted from the client 14 of the user 86 to the server 12. When the determination is negative in the step 126, the process returns to step 124. The determinations of the steps 124 and 126 are repeated until the determination is affirmative in the step 124 or the determination is affirmative in the step 126.

when the determination is affirmative in the step 126, the process proceeds to step 128. In step 128, it is determined whether or not acceptance of application to purchase admission ticket is finished due to a number of the applications of admission tickets reaching a predetermined number. Namely, in step 126, it is determined whether or not the number of the applications of admission tickets reaches a full number. When the determination is negative in the step 128, the process proceeds to step 130. In the step 130, data of the page for purchasing admission ticket including the format for purchasing admission ticket is sent to the client 14.

In step 132, it is determined whether or not the admission ticket purchase information in which the image data 68 and the personal information 70 of the user 68 are inputted in accordance with the format for purchasing admission ticket is obtained. When the determination is negative in the step 132, the server 12 standbys until the admission ticket purchase information is obtained.

When the determination is affirmative in the step 132, the process proceeds to step 134. In the step 134, the obtained admission ticket purchase information is stored in the hard disk 30 together with the identifying information 72, such as a serial number representing collating sequence of reception or the like, or bar code information, which identifies the respective admission ticket purchase information. Thus, the processes at the server 12 side is completed.

On the other hand, When the determination is affirmative in the step 128, namely, when the number of application of admission tickets reaches the full number, the process proceeds to step 136. In the step 136, and close message data (representing that the acceptance of application to purchase admission ticket is closed) is sent to the client 14, and the process proceeds to step 138.

In step 138, the admission ticket purchase information sent from the user 86 and stored in the hard disk 30 is sent to the digital laboratory system 24A as the output device 24 via the internet 18. Thus, the processes at the server 12 is completed. When the admission ticket purchase information is sent to the digital laboratory system 24A, the admission ticket purchase information is stored in the hard disk 22 connected to the LAN 26 of the consignment company 90.

Also, when the determination is affirmative in the step 124, namely, when it is determined that the communication is disconnected due to, for example, the user 86 designating to access to another homepage, the processes at the server 12 side is completed.

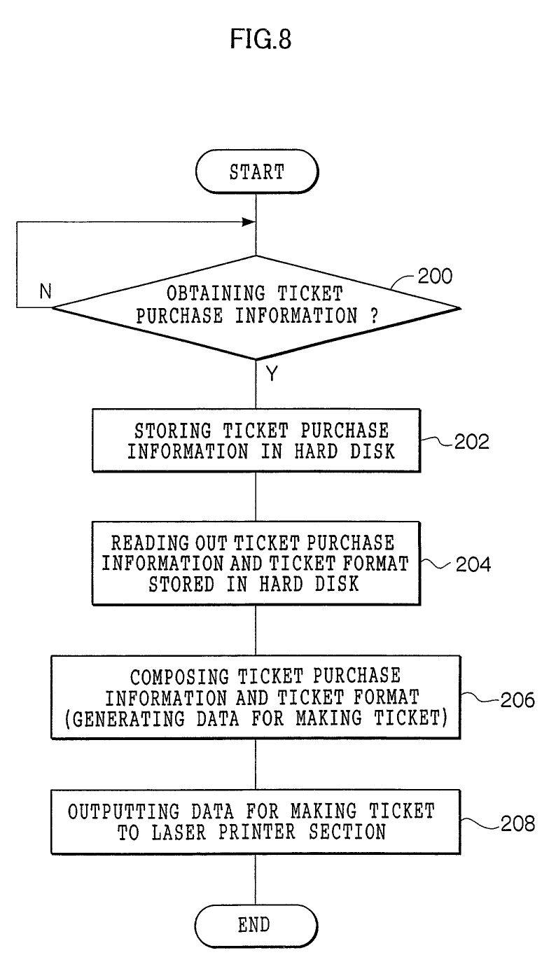

Next, processes executed in the LAN 26 including the output device 24A owned by the contractor (the consignment company 90, such as the printing company, the photographer or the like) who contracts with the manager who manages selling admission tickets, when the admission ticket is produced, will be described, with referring to a flow chart shown in FIG. 8.

In step 200, it is determined whether or not the admission ticket purchase information is obtained by the terminal device 20. Namely, in the step 200, it is determined whether or not the above mentioned admission ticket purchase information is sent from the sever 12 owned by the manager who manages selling admission tickets to the LAN 26. When the determination is negative in the step 200, the process standbys until the determination is affirmative in the step 200.

When the determination is affirmative in the step 200, the process proceeds to step 202. In the step 202, the admission ticket purchase information sent from the sever 12 owned by the manager managing selling admission tickets are stored in the hard disk in the LAN 26 together with the identifying information identifying the individual admission ticket purchase information.

In step 204, the admission ticket purchase information including the identifying information 72 stored in the hard disk 22 and the admission ticket format 66 for making admission ticket are read out to the digital laboratory system 24A in the image processing section 34.

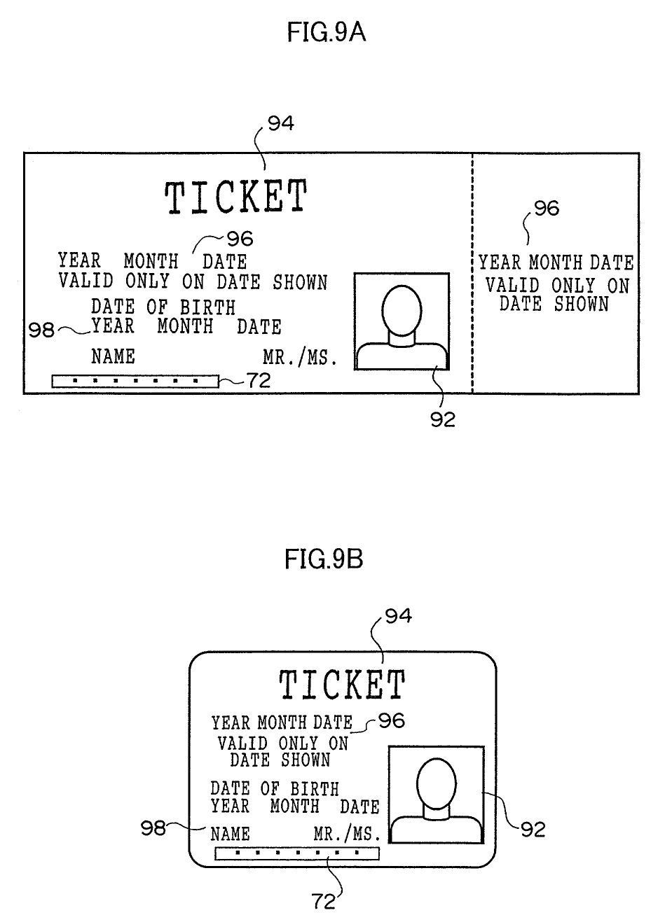

The admission ticket format 66 includes, for example, text data and the like representing a name of the admission ticket 94 and a date 96 shown in FIGS. 9A and 9B. Also, attached positions, to which an image of person 92, the personal information 70 such as a name and a date of birth 98, the identifying information 72 identifying individual admission ticket, and the like are attached, are pointed in the admission ticket format 66. The admission ticket maybe a type of an admission ticket from which a stub thereof is collected, as shown in FIG. 9A. Also, the admission ticket may be a type of an admission ticket on which magnetic information is stored in backside, or may be a magnetic card type having a strip shaped magnetic tape on which magnetic information is stored, as shown in FIG. 9B

In step 206, the data for making admission ticket is generated by composing the admission ticket format 66 and the admission ticket purchase information including the identification information 72 by the composition section 74 in the image processing section 34 in the digital laboratory system 24A. Namely, in the image processing section 34, the composition section 74 composes the admission ticket format 66, the image data 68 (the image data enabling verifying the user (individual), such as the image of the picture of the user, the image of the fingerprint of the user, or the like) included in the admission ticket purchase information, the personal information 70 formed by the text data or the like and included in the admission ticket purchase information, and identifying information 72 identifying respective admission ticket purchase information, to generate the data for making admission ticket.

Next, in step 208, the data for making admission ticket generated in the step 206 is outputted to the laser printer section 36. Accordingly, an image is recorded on the photographic printing paper P on the basis of the data for making admission ticket in the laser printer section 36. The processor section 38 effects various processing including a color development, a bleach-fix, a washing, and a drying for the photographic printing paper P. As a result, the image is formed on the photographic printing paper P, and therefore, the admission ticket is produced. As shown in FIGS. 9A and 9B, the image 92, which is sent from the client 14 owned by the user 86, enabling verifying the user (individual), such as the image of the user, the image of the fingerprint, or the like, the personal information 70 (the name and the date of the birth 98 shown in FIGS. 9A and 9B) which is sent from the client 14, and the identifying information 72 (such as a serial number representing collating sequence of reception or the like, or bar code information) corresponding to the admission ticket purchase information, are recorded on the admission ticket thus produced. Accordingly, the individual (the user) can be verified by the admission ticket.

The address for sending the admission ticket to the user 86 is recorded on the envelope by the output device 24 such as the digital laboratory system 24A, a printer or the like by using the database (the admission ticket purchase information including the identification information 72, the image data 68, and the personal information 70) stored in the hard disk 22 connected to the LAN 26. Accordingly, the envelope on which the address for sending the admission ticket to the user 86 is recorded can be made easily. By the identifying information 72 identifying respective admission ticket purchase information being also recorded on the envelope When recording the address on the envelope, the admission ticket produced by the output device 24 such as the digital laboratory system 24A and the envelope on which the address is recorded can be easily collated, therefore, the admission ticket can be easily sent to the user 86. Further, sending of admission ticket and customer information can be easily managed by using the identification information 72. Further, one output device, such as a printer, may be used for making the admission ticket and for recording the address on the envelop. Moreover, different output devices may be used for making the admission ticket and for recording the address on the envelop, respectively.

Further, an identifying information reading device, which reads the identification information 72 recorded on the admission ticket and collates the admission ticket purchase information including the identification information 72 stored in the hard disks 22 and 30 with the read identification information, can be provided at a place for a concert or a sporting event. In this case, it is possible to judge whether or not the admission ticket is illegally produced, by collating the identification information 72 recorded on the admission ticket with the identification information 72 stored in the hard disks 22 and 30 by the identifying information reading device. For example, when a serial number, a bar code, or the like is read by the identifying information reading device, and the read serial number or the bar code is collated with the identification information 72 stored in the hard disks 22 and 30 by the identifying information reading device, in a case in which identifying information corresponding to the read serial number or the bar code is not found, it can be judged that the admission ticket is illegally produced.

As mentioned above, in the admission ticket producing system 10 relating to the present embodiment in the present invention, processes from applying to purchase admission ticket to sending of the admission ticket can be easily executed by the user 86 merely operating the client 14 to input the admission ticket purchase information. Further, because the image 92 enabling verifying the user 86 is recorded on the admission ticket thus produced, this admission ticket can make it difficult for the admission ticket to be illegally resold and/or used.

### Second Embodiment

A wireless (radio) telephone having an image pickup element such as CCD or the like is proposed. In this type of the wireless telephone, photographing a person or the like, and transmitting and receiving image data obtained by photographing via a radio telephone network, are possible.

In the admission ticket producing system 10 relating to the first embodiment of the present invention, the user applies to purchase admission ticket by using the client owned by the user. In an admission ticket producing system relating to the second embodiment, the wireless telephone provided with the image pickup element mentioned above is used, and the user applies to purchase admission ticket by using the radio telephone network or a public telephone network. The second embodiment of the present invention will be described in detail. Hereinafter, the same reference numerals are applied to the same components, members and structures as those of the first embodiment and the descriptions thereof are omitted.

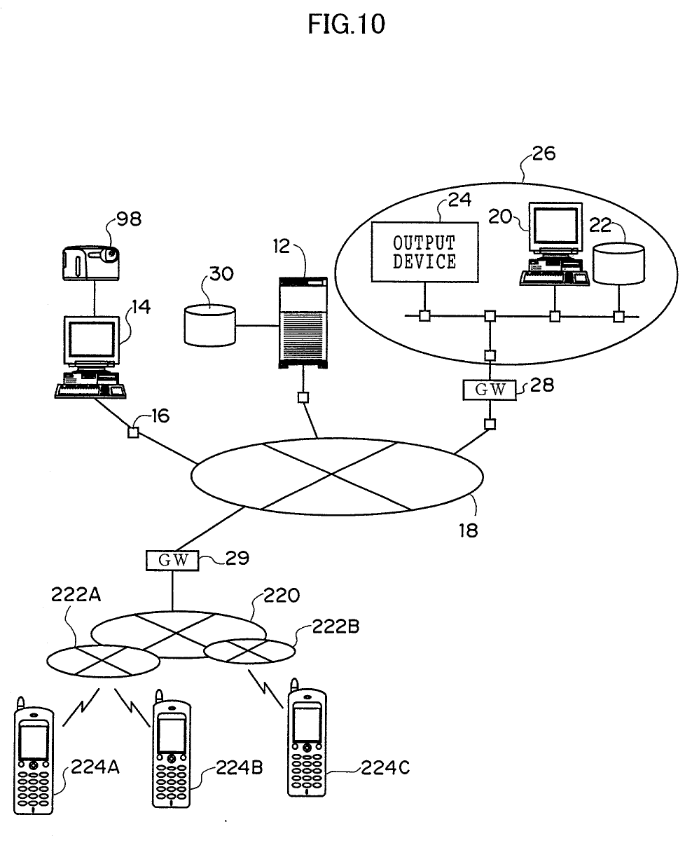

When compared the admission ticket producing system relating to the second embodiment with the admission ticket producing system 10 relating to the first embodiment, public telephone network 220 constructed and provided by telephone company of each country or region is interconnected by gateway system 29, as shown in FIG. 10. For example, the public telephone network includes PSTN (Public Switched Telephone Network) and ISDN (Integrated Service Digital Network), and the internet 18 is provided.

The telephone network includes various type of wireless (radio) telephone networks 222A and 222B. The radio telephone networks 222A and 222B can provide portable telephones (cellular phones) 224A, 224B, 224C with function services such as a function for receiving and transmitting data, a function for recognizing calling number, and the like.

The portable telephones 224A, 224B, 224C are provided with an image pickup element such as CCD, or the like. Therefore, the portable telephones 224A, 224B, 224C enable transmitting and receiving image data obtained by photographing via the radio telephone networks 222A and 222B.

Note that the server 12, the connecting device 16, the internet 18, LAN 26, the gateway systems 28 and 29, the public telephone network 220 and the radio telephone networks 222A and 222B correspond to the information obtaining section and the communicating and obtaining section of the aspects of the present invention, the portable telephones 224A, 224B, 224C correspond to the terminal of the aspects of the present invention.

Thus, in the admission ticket producing system relating to the second embodiment, the portable telephone (224A, 224B, 224C) is used instead of the client 14 in the admission ticket producing system relating to the first embodiment. Therefore, in the second embodiment, it is possible to apply to purchase admission ticket in the similar way of the first embodiment by using the portable telephones 224A, 224B, 224C. Namely, the image data obtained by photographing a person by the portable telephone (224A, 224B, 224C) is transmitted.

Processes executed at the portable telephone (224A, 224B, 224C) are substantially the same as the processes executed at the client 14 of the first embodiment. However, instead of the image data, such as the image of the picture of the user photographed by the digital camera or the like, or the finger print of the user read by the scanner or the like, which enables to verify the user (individual), image data obtained by photographing the person by the portable telephone (224A, 224B, 224C) is used in the second embodiment when the admission ticket purchase information is inputted. Note that inputting the admission ticket purchase information is executed in the step 104. Also, the admission ticket purchase information is inputted from the portable telephone (224A, 224B, 224C) in the second embodiment. Thus, applying to purchase admission ticket can be executed easily in the similar way of the first embodiment.

Producing and sending of the admission ticket applied for purchasing by the user by using the portable telephone (224A, 224B, 224C) are executed in the similar way of the first embodiment. Thus, as mentioned above, processes from applying to purchase admission ticket to sending of the admission ticket also can be executed easily by using the wireless telephone such as the portable telephone (224A, 224B, 224C).

In the second embodiment mentioned above, applying to purchase admission ticket is executed by using the wireless telephone provided with the image pickup element. However, the present embodiment is not limited to the same. Applying to purchase admission ticket can be executed by using a wireless terminal in which PDA terminal or a note-type personal computer is combined with a digital camera or the like.

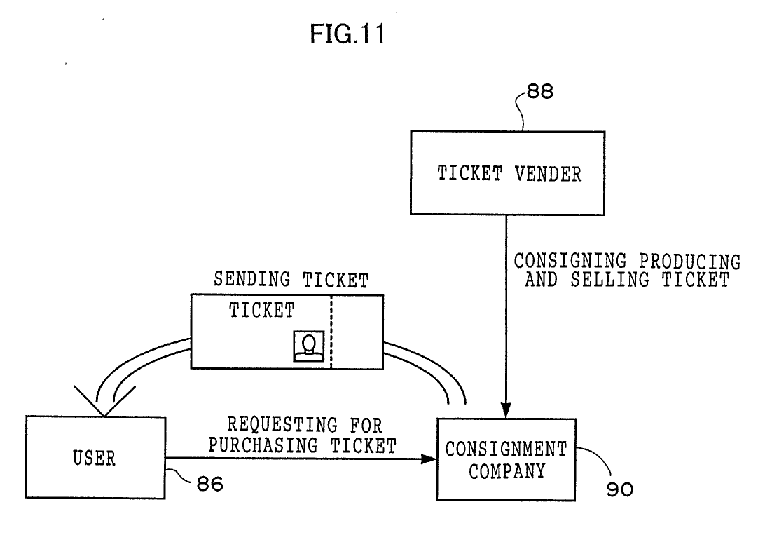

In the first and second embodiments mentioned above, the user applies to purchase admission ticket with the manager (the admission ticket selling company 88) who manages selling admission tickets, the admission ticket selling company 88 orders to produce the admission ticket for the consignment company 90, such as the printing company, the photographer or the like, contracting with the admission ticket selling company 88, the consignment company 90 produces the admission ticket, the consignment company 90 delivers the produced admission ticket to the admission ticket selling company 88, and the admission ticket selling company 88 sends the admission ticket to the user. However, there may be a case (shown in FIG. 11) as follows. The admission ticket selling company 88 consigns in advance producing and selling admission ticket with the consignment company 90, such as the printing company, the photographer or the like. The user 86 directly applies to purchase admission ticket with the consignment company 90, such as the printing company, the photographer or the like. The consignment company 90 sends the admission ticket to the user. This case is easily realized in such a manner in which the LAN 26 of the consignment company 90, such as the printing company, the photographer or the like, includes the server 12 and the hard disk 30 of the manager (the admission ticket selling company 88) who manages selling admission tickets.

In the embodiments mentioned above, the admission ticket is applied to purchase by using the internet. However, the preset invention is not limited to the same. The admission ticket purchase information including the personal information and the user verification image mentioned above may be forwarded by mailing, and the admission ticket purchase information including the personal information and the user verification image may be inputted to the terminal device of the consignment company 90 or the admission ticket selling company 88.

As mentioned above, in the present invention, the attendant information including at least the attendant verification image enabling verifying the attendant and the personal information of the attendant is obtained via the internet or mailing, and the attendant information and the ticket information including at least the date if entrance are recorded on an admission ticket. Accordingly, the admission ticket of the present invention can make it difficult for the admission ticket to be illegally resold and/or used, and can be purchased easily.

What is claimed is:

1. An admission ticket producing apparatus comprising:
an information obtaining section which obtains attendant information including at least an attendant verification image enabling verifying an attendant and personal information of the attendant, obtained from the outside; and
a recording section which records the attendant information obtained by the information obtaining section and admission ticket information for permitting entrance, on an admission ticket.

2. An admission ticket producing apparatus according to claim 1, wherein the information obtaining section obtains an address of the attendant as the personal information, and the recording section records the address of the attendant on an envelope member for sending the admission ticket to the attendant on the basis of the personal information obtained by the information obtaining section.

3. An admission ticket producing apparatus according to claim 1, wherein the information obtaining section is a communicating and obtaining section which transmits and receives information by communication.

4. An admission ticket producing apparatus according to claim 2, wherein the information obtaining section is a communicating and obtaining section which transmits and receives information by communication.

5. An admission ticket producing apparatus according to claim 2, wherein the recording section further records verifying information corresponding to the attendant information on the admission ticket and the envelope member.

6. An admission ticket producing system including:
a terminal which inputs and outputs attendant information including at least an attendant verification image enabling verifying an attendant and personal information of the attendant; and
an admission ticket producing apparatus comprising:
an information obtaining section which obtains at least the attendant information; and
a recording section which records the attendant information obtained by the information obtaining section and admission ticket information for permitting entrance, on an admission ticket.

7. An admission ticket producing system according to claim 6, wherein the attendant information and the admission ticket information recorded on the admission ticket by the recording section are collated with condition for permitting entrance.

8. An admission ticket producing system according to claim 6, wherein the terminal is a wireless terminal enabling photographing an image and inputting the attendant information.

9. An admission ticket producing system according to claim 7, wherein the terminal is a wireless terminal enabling photographing an image and inputting the attendant information.

10. An admission ticket producing and selling method for producing and selling an admission ticket on the basis of application for purchasing admission ticket, including the steps of:
inputting attendant information including at least an attendant verification image enabling verifying an attendant and personal information of the attendant by an inputting section;
outputting the attendant information inputted at the step of inputting; and
recording the attendant information outputted at the step of outputting and admission ticket information for permitting entrance, on the admission ticket.

11. An admission ticket producing and selling method according to claim 10, wherein an address of the attendant is inputted by the inputting section as the personal information, and the method further includes the step of address recording in which the address of the attendant is recorded on an envelope member for sending the admission ticket to the attendant on the basis of the personal information inputted at the step of inputting.

12. An admission ticket producing and selling method according to claim 11, further including the steps of:
admission ticket recording for recording identifying information corresponding to the attendant information on the admission ticket; and
envelope member recording for recording said identifying information on the envelope member on which the address of the attendant is recorded in the step of address recording.

13. An admission ticket producing and selling method according to claim 10, further including the step of collating in which the attendant information and the admission ticket information recorded in the step of recording are collated with condition for permitting entrance.

14. An admission ticket producing and selling method according to claim 11, further including the step of collating in which the attendant information and the admission ticket information recorded in the step of recording are collated with condition for permitting entrance.

15. An admission ticket producing and selling method according to claim 12, further including the step of collating in which the attendant information and the admission ticket information recorded in the step of recording are collated with condition for permitting entrance.

16. A recording medium on which a program, readable by a computer, for executing an admission ticket producing and selling method for producing and selling an admission ticket on the basis of application for purchasing admission ticket, including the steps of: inputting attendant information including at least an attendant verification image enabling verifying an attendant and personal information of the attendant by an inputting section; outputting the attendant information inputted at the step of inputting; and recording the attendant information outputted at the step of outputting and admission ticket information for permitting entrance, on the admission ticket, is recorded.
